(19) United States
(12) Patent Application Publication
(10) Pub. No.: US 2007/0187342 A1
(43) Pub. Date: Aug. 16, 2007

(54) BACKWASH TANK AND PROCESS

(76) Inventors: Cort ABNEY, Cameron Park, CA (US); Scott Myers, Rescue, CA (US)

Correspondence Address: GROSS & ASSOCIATES, 1415 L STREET SUITE 1000, SACRAMETO, CA, 95814, US

(21) Appl. No.: 11/674,102

(22) Filed: Feb. 12, 2007

Related U.S. Application Data
(60) Provisional application No. 60/772,159, filed on Feb. 10, 2006.
(60) Provisional application No. 60/778,697, filed on Mar. 2, 2006.

(51) Int. Cl. B01D 24/46

(52) U.S. Cl. 210/793; 210/275; 210/532.1

(57) ABSTRACT

This invention provides a device for removing particulates from a liquid. The invention comprises a first chamber having an outlet and an inlet, operably configured to receive into the first chamber a liquid stream having particulates suspended therein. The device further includes a second chamber having an inlet, a top, a bottom, a processed liquid outlet and a sealable settlement outlet, the inlet being in fluid communication with the outlet of the first chamber and being disposed within the second chamber closer to the bottom of the second chamber than the top; and, a third chamber being in fluid communication with the processed water of the second chamber and having an exit line operably configured to deliver processed water. The first chamber further includes a floor and the inlet of the first chamber is operably configured to direct the liquid stream is a direction substantially parallel to the floor.

### CROSS REFERENCE TO RELATED APPLICATION

This application is a nonprovisional application of U.S. Applications Nos. 60/772,159, filed on Feb. 10, 2006 and 60/778,697, filed on Mar. 2, 2006, which are incorporated, in their entirety, herein by reference.

### BACKGROUND OF THE INVENTION

1. Field of Invention

The present invention relates to filter backwash processing tanks and the process of treating filter backwash from water treatment facilities.

2. Description of Related Art

The treatment of water for potable use often consists of employing filters to remove organic or inorganic contaminants from the untreated water. Filters can include a variety of materials, including sand, diatamacious earth, anthracite, coated granular materials, for example green sand, membranes, and other proprietary granular media. As water passes through the filter, contaminants are either physically blocked by the filter, or adhere to the filter media due to a chemical affinity between the media and the contaminant.

A common filter used in potable water treatment consists of either a single media or multi-media bed to remove both organic and inorganic contaminants. Water passes through the filter media from top to bottom by either gravity flow or under pressure. The filter media must be cleaned or “backwashed” on a regular basis to remove the filtered contaminants that build up on the filter during the treatment process. A backwash cycle typically consists of reversing the flow of water through the filter, from bottom to the top, to lift or expand the filter, thereby enhancing the backwash process. A backwash cycle may last from 10 minutes to over one hour, depending on the contaminants, the filter, media, and the system.

The wastewater stream produced from the backwash process results in a substantial volume of water, containing a high concentration of contaminants. The wastewater stream can either be sent to the local sewer, wastewater treatment plant, or processed on-site. Often the permitting costs and or sewer capacity may limit discharging the wastewater stream directly to the sewer, so on-site processing is often the preferred option.

The goal of processing backwash water is to separate filtered contaminants from the wastewater stream to minimize the actual volume of waste that requires disposal, for example to the local sewer. The reclaimed water is sent back to the head of the water treatment process and blended with the untreated water supply.

A conventional backwash water processing system consists of either one or two large tanks. The wastewater stream is pumped into a tank and the contaminants are allowed to settle to the bottom. In theory, once the contaminants have settled, water is pumped from the top of the tank and reclaimed by sending it back to the untreated water stream for filtering. This conventional “batch-type” process, which receives and processes a specified volume of water before receiving the next volume, has several disadvantages. One such disadvantage is that each time a filter backwashes, the wastewater stream agitates the contaminants that are supposed to be precipitated in the settling process. An additional disadvantage is that if the treatment filters are not in operation, the reclaimed water cannot be returned and must be held in the tank until the filters are operating.

In a conventional two-tank design, a holding tank is used in front of the settling tank to minimize disruption of the settling process. Conventional two-tank designs could be modified to add a third tank to store the reclaimed water before returning it to the treatment process. However, such a modification of adding this third tank creates another disadvantage of conventional backwash tanks, in that a large amount of land space is required to have a multiple separate tank system.

### SUMMARY OF THE INVENTION

It is an object of the present invention to overcome the drawbacks and shortcomings of conventional backwash tanks and processes. In an exemplary embodiment of the present invention a three part tank is provided that processes filter backwash water in a continuous-type flow process. In this exemplary embodiment, the three tanks or chambers are built in one single tank so as to reduce the land use footprint required over conventional systems. The three chambers of the present invention includes an entry bay, settling bay and a clearwell bay. The integrated design of three separate chambers in one tank minimizes the cost of construction and maintenance, while greatly reduces the space needed to build the backwash process equipment.

In another embodiment, where a water treatment facility already has a settling tank, the process of present invention can be utilized to include the existing tank structure such that any combination of the three chambers can be made into a single tank with two chambers. For example, if an existing structure is a settling tank, then a tank with two chambers can be constructed such that the two chambers are a holding bay and a clearwell bay.

Additionally, the inclusion of the three chambers allows reclaimed water from the wastewater stream to be stored before it is returned to the water treatment facility, thereby advantageously allowing for the processing of the backwash, water when filters are not in operation.

The present invention further include a process or method which simulates continuous, non-stop, wastewater stream type treatment. Conventional processes are of a batch type, where in the wastewater stream must sit and settle before more wastewater stream can be added. In the present invention, wastewater stream containing particulate can be processed continuously without interruption.

The present invention receives the wastewater stream, into the entry bay where the particulate is maintained suspended in the wastewater. The wastewater with the particulate is transferred into the settling bay at a rate near the settling velocity of the particulate. Within the settling bay, the particular settles and processed wastewater (without particulate) is transferred into the clearwell bay. The clearwell bay holds the processed wastewater until the process wastewater is transferred back to the treatment faculty for reuse. The present invention further includes the process of removing the settled particulate from the settling bay for disposal.

Further, the present invention incorporates several features to make operation, maintenance, access and cleaning, of the tank and chambers easier.

The present invention provides a device for removing particulates from a liquid. The device comprises a first chamber having an outlet and an inlet, operably configured to receive into the first chamber a liquid stream having particulates suspended therein. The device also includes a second chamber having an inlet, a top, a bottom, a processed liquid outlet and a sealable settlement outlet, the inlet being in fluid communication with the outlet of the first chamber and being disposed within the second chamber closer to the bottom of the second chamber than the top. Still further, the device includes a third chamber being in fluid communication with the processed water of the second chamber and having an exit line operably configured to deliver processed water.

Further, this invention provides a wastewater backwash multi-chambered cleaning device. The wastewater backwash multi-chambered device comprises an entry bay having a floor, a sump, and at least one inlet operably configured to connect with a backwash source and when in use to direct the backwash from the backwash source in a substantially horizontal direction along the floor, the sump being recessed into the floor adjacent the at least one inlet. The wastewater backwash multi-chambered device further includes a clearwell bay having a discharge line, and being disposed in the entry bay. Also the wastewater backwash multi-chambered device has a settling bay being disposed in the clearwell bay and having a weir, a conical shaped floor with a settlement sump at the apex, and an inlet manifold being disposed within the settling bay, operably configured to receive backwash from the sump of the entry bay and discharge the backwash in a horizontal direction, wherein the settlement sump has a closeable opening and the weir is in fluid communication with the clearwell bay.

The present invention also presents a method of treating wastewater backwash, comprising the steps of acquiring unprocessed liquid containing suspended particulate matter; maintaining the particulate matter suspended within the unprocessed liquid; transferring the unprocessed liquid containing suspended particulate matter to a settling process; processing the unprocessed liquid by settling out the particulate matter from the liquid; storing the processed liquid without particulate matter; and, outputting the processed liquid.

These and other features and advantages of this invention are described in, or are apparent from, the following detailed description of various exemplary embodiments of the devices and methods according to this invention.

### BRIEF DESCRIPTION OF THE DRAWINGS

Various exemplary embodiments of this invention will be described in detail, with reference to the following figures, wherein:

FIG. 1 is a top view of a tank with three chambers made in accordance with an exemplary embodiment of the present invention;

FIG. 2 is a partial cut-away side view of the tank of FIG. 1;

FIG. 3 is a top view of a settling chamber made in accordance with the present invention;

FIG. 4 is a cross sectional view of the settling chamber of FIG. 3 along line 4-4 in FIG. 3;

FIG. 5 is a cross sectional view of a wastewater stream inlet pipe made in accordance with the present invention taken along line 5-5 in FIG. 1;

FIG. 6 is a top view of the inlet pipe of FIG. 5 and rotated clockwise ninety degrees;

FIG. 7 is a cross sectional view of the inlet pipe taken along line 7-7 in FIG. 6;

FIG. 8 is a cross sectional view of an entry bay sump and drain pipe of FIG. 6 taken along line 8-8 in FIG. 6;

FIG. 9 is a detail view of an access door made in accordance with the present invention as shown in FIG. 1;

FIG. 10 is a cross sectional view of the access door taken along line 10-10 in FIG. 9;

FIG. 11 is a cross sectional view of the access door taken along line 11-11 in FIG. 9;

FIG. 12 is a cross sectional view of an overflow pipe taken along line 12-12 in FIG. 1;

FIG. 13 is a an overhead view of the overflow pipe supports shown in FIG. 12;

FIG. 14 is an alternative embodiment of a device made in accordance with the present invention; and,

FIG. 15 is a flow chart of a method provided in accordance with the present invention.

### DETAILED DESCRIPTION

The backwash tank device 10 made in accordance with the present invention is an integrated tank 10 consisting of a single, multi-chambered tank in the present embodiment. The device 10 provides for a continuous, non-stop, wastewater stream water type treatment, wherein the tank 10 is designed in accordance with this invention receives a liquid containing particulate that requires treatment. In this embodiment, the tank is operably configured to receive backwash wastewater from filters (not shown) of a water treatment facility (not shown), as will be described further below. The tank 10, when in use, will receive the liquid containing the particulate from the filters of the water treatment facility, separate the particulate from liquid, store the liquid without the particulate (processed liquid) and transfer the process liquid back to the treatment facility.

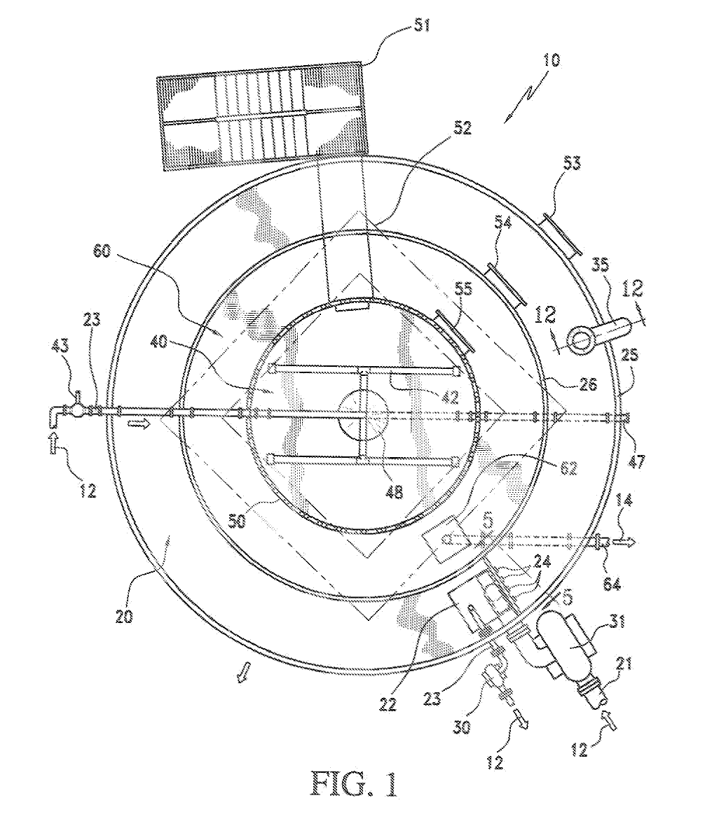

In the present embodiment, the single enclosed tank 10 is divided into three chambers consisting of a first chamber or entry bay 20, a second chamber or settling bay 40 and a third chamber or clearwell bay 60 as shown in FIG. 1. The entry bay 20 is the outer most chamber. The settling bay 40 is the center chamber. The clearwell bay 60 is disposed between the entry bay 20 and the settling bay 40. The integration of the three separate chambers 20, 40 and 60 in one tank minimizes the cost of construction and maintenance and greatly reduces the space needed to place the backwash process device 10. However, it should be appreciated that in other various exemplary embodiments, the three chambers could be separate tanks or a two chambered tank of any combination of the three chambers. The device 10 further includes a plurality of process pumps and return pumps.

In the present embodiment, each of the chambers, the first, second and third, 20, 40 and 60 are generally circular. However, it should be appreciated the in other various exemplary embodiments, the shape of the chambers could be other geometric shapes, such as but not limited to, oval or square. Further, chambers 40 and 60 are within chamber 20 and all three chambers 20, 40 and 60 have the same center point.

The device 10 in this exemplary embodiment is designed to receive a liquid containing particulate or stream 12. It is preferred to receive backwash waste stream or wastewater 12 from the filters of the water treatment facility (not shown). The treatment facility filters require cleaning and this is accomplished by directing water backwards through the filters. This backwards flow through the filters loosens the contaminants in the filters creating a backwash wastewater containing particulate 12 to be sent to the backwash tank device 10. The present invention will settle the particulate out of the wastewater 12 and return this processed water 14 to the treatment facility for further filtration and use in the water system.

In this embodiment, it is preferred that the stream 12 be feed directly into the entry bay 20 from the filters of the water treatment facility. However, if required, the stream 12 can be feed into the entry bay 20 via a feed pump 31. A purpose of the entry bay 20 is to avoid disruption to the settling process during a backwash by keeping any water in the settling bay 40 separate from backwash wastewater inflow 12. The entry bay 20 dissipates energy generated from the backwash process, and provides detention of the backwash wastewater 12 while the wastewater 12 is further processed at a slower rate in the settling bay 40.

The entry bay 20 includes a first wall 25, a second wall 26 and a floor 27. The first wall 25 is an outer wall. The second wall 26 separates the entry bay 20 from the third chamber or clearwell bay 60, as shown in FIG. 1. However, it should be appreciated that in other various exemplary embodiments, the entry bay and the clearwell bay could be non-integrated and not share a wall.

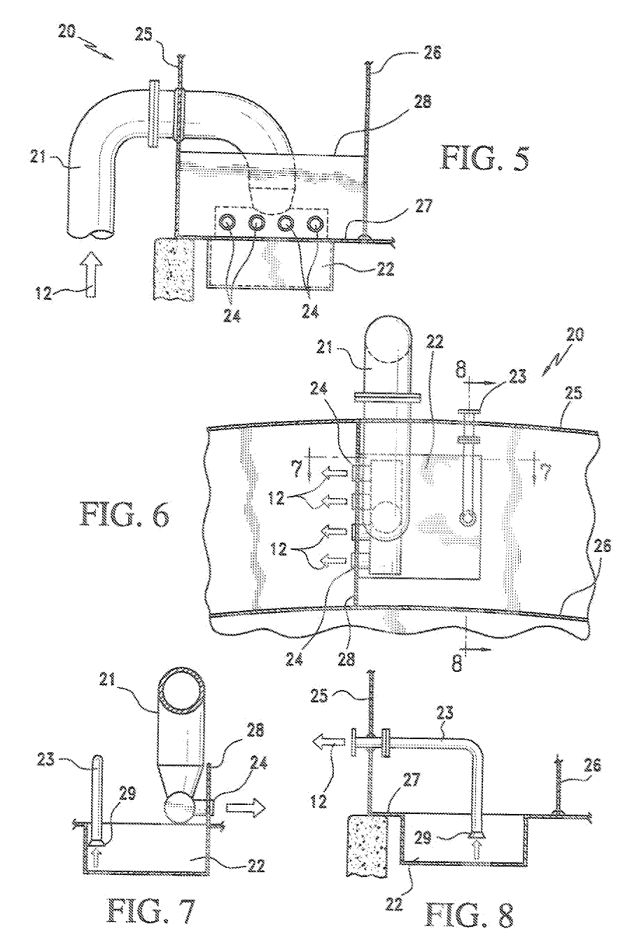

The entry bay 20 further includes a wastewater stream inlet pipe 21, an entry bay sump 22 and an entry bay outlet pipe 23, as shown in FIGS. 1 and 5 through 7. The wastewater stream inlet pipe 21 provides the inflow of wastewater stream 12 to the tank. The wastewater stream inlet pipe includes a stream directing device 24. The directing device 24 is in fluid communication with the inlet pipe 21 and the entry bay 20. The directing device 24 is operably configured to agitate the water so as to keep solids from accumulating in the entry bay 20. The directing device 24 in this embodiment is directing the inlet stream of wastewater 12 in a direction so as to circulate the wastewater 12 within the entry bay 20 around the clearwell bay 60. This arrangement with keep solids contained with the inlet wastewater 12 suspended in the wastewater 12 within the entry bay 20 and help prevent those solids from settling on the bottom of the entry bay 20.

The directing device 24 in this embodiment is a series of nozzles. The nozzles are oriented in the same direction. Particularly, the nozzles are oriented to direct the incoming wastewater stream 12 in a direction generally horizontal to a floor 27 of the entry bay 20. The present embodiment includes four nozzles 24, however, it should be appreciated that in other various exemplary embodiments, more or less nozzles may be used and the individual nozzles could be oriented in different directions relative to each other. Further, it should also be appreciated that in other exemplary embodiments, the directing device could be other devices, such as but not limited to jets, orifices, simple tubes or the like. Yet further, it should be appreciated that in other various embodiments, the entry bay may have a plurality of inlet pipes 21 and directing devices 24 in various locations throughout the circumference of the entry bay. Having more than one inlet and/or directing device enhances the suspension of solids within the water in the entry bay.

The backwash wastewater 12 with suspended particles in the entry bay 20 is then continuously transferred, by a process pump 30, to the settling bay 40 for further processing at a controlled rate of flow. The controlled rate of flow is dependent upon the settling velocity of the precipitates in the wastewater 12. The controlled rate of flow can be varied through the operation of the pump 30.

The entry bay sump 22 is disposed in the entry bay 20. Preferably, the sump 22 is disposed behind the inlet pipe 21 opposite of the direction of the directing device 24. Further, it is preferred that the sump 22 be separated and on opposite sides of a curtain wall 28 from the directing device 24. The sump 22 is further preferred to be recessed below the elevation of the entry bay floor 27. The entry bay sump 22 has a generally rectangular shape, but other shapes could be utilized. A self-cleaning scouring action of the entry bay is achieved by jetting the wastewater stream 12 horizontally into the first chamber 20 on one side of the curtain wall 28, and pumping wastewater stream 12 out of the sump 22 on the opposing side of the curtain wall 28. The curtain wall 28 will direct precipitates into the sump 22 for processing.

Further, it should be appreciated that in other various embodiments, the entry bay may have a plurality of sumps 22 in various locations throughout the circumference of the entry bay. Having more than one sump enhances the suspension of solids within the water in the entry bay.

The process pump 30 is located on the outside of the entry bay wall 25 and moves wastewater 12 from the entry bay 20 to the settling bay 40. The entry bay outlet pipe 23 extends below the entry bay floor 27 into and into the sump 22 to collect and convey the wastewater stream with suspended particulates to the settling bay 40. The outlet pipe 23 is flared at the intake end 29. The intake end 29 is set close to the bottom of the sump 22, increasing velocities near the intake 29, and thereby scouring solids from the sump 22.

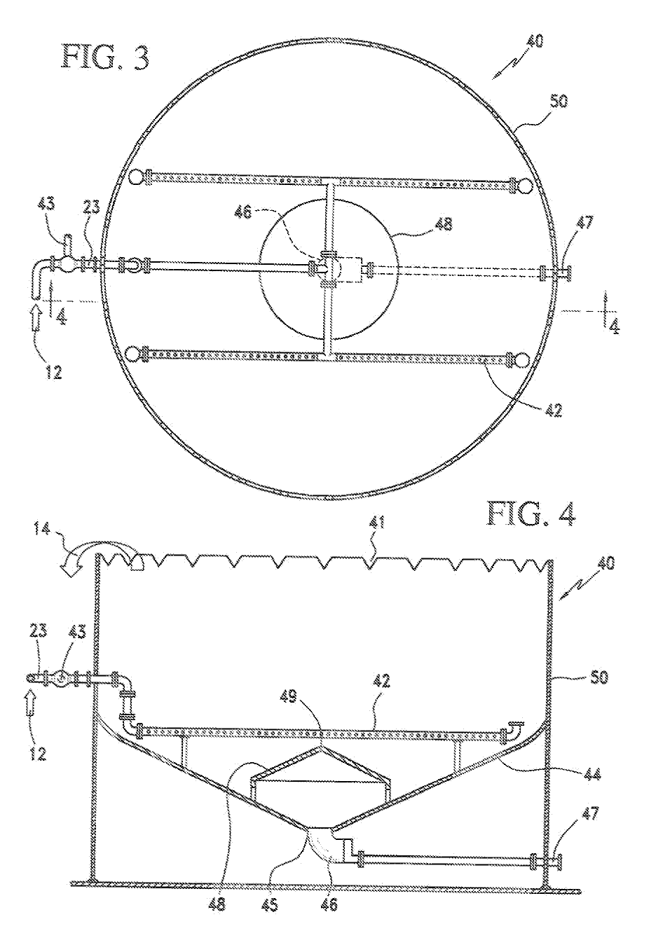

The second chamber or settling bay 40, as shown in FIGS. 3 and 4, includes a floor 44 and a wall 50, forming an isolated chamber operably configured to receive the wastewater stream 12 pumped from the entry bay 20 into the settling bay 40 through a settling bay distribution inlet 42. The inlet 42 is in fluid communication with the entry bay 20 via the outlet pipe 23.

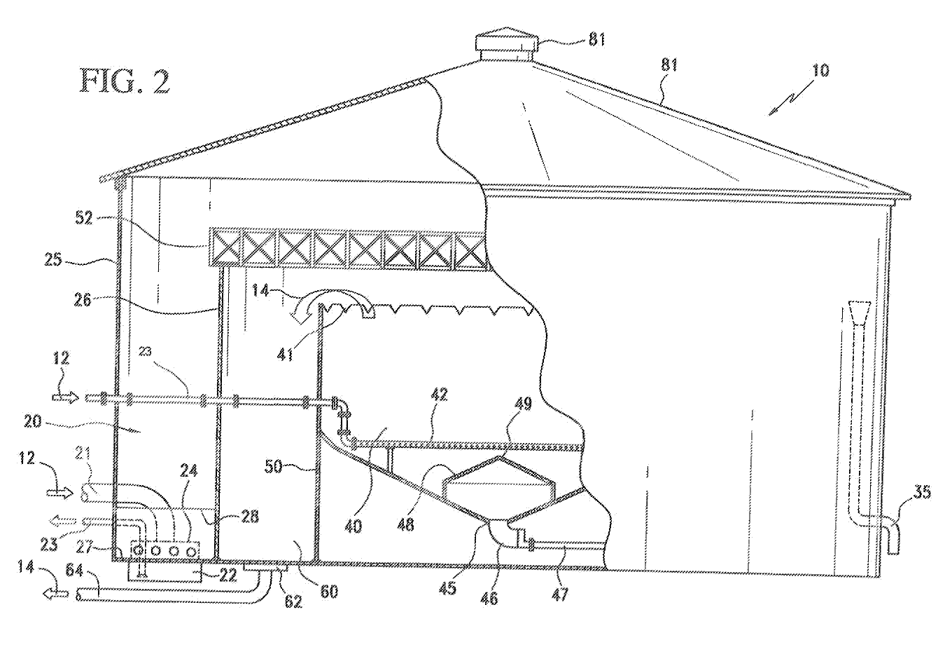

The wall 50 has a top rim 41 and the wall 50 of the settling bay 40 is also the inner wall of the clearwell bay 60, as shown in FIG. 2.

The wastewater 12 is pumped from the entry bay outlet pipe 23 at a controlled rate depending on the settling velocity of the sediment or particles in the wastewater 12 into the settling bay 40 via the settling bay inlet 42. An operator may control the rate of flow into the settling bay 40 depending on the liquid, types of particulates suspended within the liquid and the clarity of the processed water 14 desired. The wastewater 12 rises up in the settling bay 40 at a rate that is less than the settling velocity of the precipitate, thus allowing settling of the solids to occur. As the settling process continues, precipitates and solids within the wastewater stream 12 settle to the floor 44 and process water 14 rises to the top of the settling bay 40.

The inlet 42 is preferred to be disposed closer to the floor 44 of the settling bay than the top 41 of the wall 50. With the inlet 42 closer to the floor 44 than the top 41, processed water 14, without solids or sediment, which rises to the top 41 of the settlement bay 40 is not mixed with incoming stream that include solids. The inlet 42 is preferred to distribute the water horizontally into the settling bay. In this embodiment, the inlet 42 includes a manifold that has a plurality of orifices that introduce the stream 12 into the second chamber 40 in a substantially horizontal alignment.

Horizontal inlet distribution is preferred so that any sediment or participates falling to the floor 44 of the settlement bay 40 is not directly agitated by the incoming stream. Further, it is preferred that the manifold 42 have a generally “H” shape as shown in FIG. 3. Dispersing the inlet stream 12 across a wider area and through multiple inlets will also assist in reducing the agitation of any sediment settling to the floor 44 of the settlement bay 40. It should be appreciated that in other various exemplary embodiments, other manifold designs and shapes may be used as well as other types of inlets other than a manifold.

The settling bay 40 further includes an optional chemical feed line 43 as shown in FIGS. 3 and 4. The chemical feed line 43 allows the injection of chemical coagulants (not shown). The chemical coagulants can be added to the wastewater 12 as the wastewater 12 enters the settling bay 40 to increase the settling characteristic of the particulate with the wastewater 12.

The floor 44 of the settling bay 40 in the present embodiment is sloped or inverted cone shape having an apex 45 to allow settled precipitate to be pulled by gravity to the apex 45 the settling bay into a solid waste collection sump 46. With this arrangement, mechanical means to collect the settled precipitate is not required. Not having mechanical means enhances the processing or separation of the precipitates because introducing mechanical means to collect precipitates can often agitate the precipitates and thus diminish the settling process. However, it should be appreciated that mechanical means to assist in the collection of the precipitates is contemplated so long as the means employed does not disrupt the settling process described above. It should be appreciated that in other various exemplary embodiments, other floor shapes may be used.

The settling bay 40 further includes an optional secondary cone 48, which is positioned above the apex 45 and the solids collection sump 46. The secondary cone 48 has an apex 49 pointed up and away from the apex 45 of the settling bay bottom 44. The secondary cone 48 directs particulate towards the cone shape floor 44. This redirecting of the settling particulate to the cone floor 44 assists in reducing agitation of the settling bay 40 and as a natural shear to enhance the settled particulate into the collection sump 46. The second cone 48 includes does not restrict the flow the settled particulate into the sump 46 by the pull of gravity.

The settled precipitate solids are collected in the solids collection sump 46. Settled particulate is transferred from the solids collection sump 46 of the second chamber 40 to a terminus point (not shown) through the exit pipe or conveyance piping 47 at the base of the second chamber 40. The terminus may consist of a sewer, drying beds, mechanical press, etc. The discharged though the exit pipe 47 is further aided by an automated process valve (not shown) to deliver the solid precipitate to another terminus such as, but not limited to, sewer, drying beds or mechanical press for example. An automated process valve, not shown, can be utilized on the exit pipe 47 to control the release the solid precipitate in the sump 46. Using an automate process valve will allow the operator to control the time of day and duration of the release. This will allow a treatment facility to be located and permitted in an area where the local sewer system is undersized. The present invention allows the waste discharged to a local sewer to be released during times of off-peak flows so as to reduce costs. The settling bay exit pipe 47 also preferably includes a flow meter, not shown, to continuously monitored and track discharge rates and volumes. It should be appreciated that this invention contemplates the use of computer systems, sensors and logic to control liquid levels, transfers of liquid and transfers of particulate using such computer devices as is common in the art.

As the processed water 14 in the settling bay 40 rises it will spill over through the top edge 41 of the wall 50 into the clearwell bay 60, as shown in FIG. 2. The top rim 41 of the wall 50 acts as a weir. As shown in FIG. 2, it is preferred that the top rim 41 include a plurality of “V”-notches. The V-notched weir will allow the processed wastewater 14 to flow out of the settling bay 40 and into the clearwell bay 60 causing only minimal disruption and currents within the settling bay 40. As noted above, it is preferred to cause little disruption in the settling bay 40 so that the solids or sediment fall to the bottom of the bay 40. Having V-notches in the top rim 41 prevent the creation of substantial currents in the wastewater contained in the settling bay and thus less agitation of the settling precipitates.

Further, it should be appreciated that in other various exemplary embodiments, the settling bay 40 can be configure by other means to allow the transfer of process water into the clearwell bay that do not cause a disruption within the settling bay. For example, an enclosed sealed and pressurized settling bay with transfer pipes would permit the continuous transfer of processed water into the clearwell bay without causing disrupting currents within the settling bay.

The third chamber or clearwell bay 60 receives the processed water 14 from the settling bay 40 through the V-notches of the top rim 41. The clearwell bay 60 provides a detention or holding area of the processed water 14 before the processed water 14 is returned or reclaimed to the treatment plant. The clearwell bay 60 allows continual processing of the wastewater stream 12 even when the treatment plant filters are not operating. The clearwell bay 60 enables the device 10 to operate in a continuous flow; therefore the backwash wastewater 12 can be processed continually without dependence on operation of the treatment filtering process.

The third chamber 60 includes a sump 62 and a discharge line 64, as shown in FIG. 2. The processed water 14 enters the discharge line 64 through the sump 62. In the present embodiment, gravity is used to transfer the processed water 14 out of the third chamber 60. However, it should be appreciated that in other various exemplary embodiments other methods common in the art of transferring liquids may be used, for example pumps.

In conventional systems, it is not preferred to transfer processed backwash water back into a treatment facility's untreated stream (pre-filter) process without being mixed with untreated water. In a conventional typical water treatment facility processed backwash water is limited to a percentage of the total untreated flow. Thus, in conventional backwash wastewater devices, reclaimed water processing is limited to a percentage of the total filtered water flow and only when filters are operating. In the present invention, the clearwell bay 60 acts as a holding tank to allow the backwash process to continue even when the treatment facility filters are not in operation. Therefore, the device 10 is not limited as conventional wastewater devices, and can operate anytime.

Each of the three chambers 20, 40 and 60 of the device 10 includes self-cleaning features. Having self cleaning attributes reduces the maintenance costs, uptime and overall efficiency of the device. For example, the entry bay 20 is designed to minimize regular maintenance by directing the wastewater 12 entering the first chamber 20 horizontally at the bottom 27 of the entry bay 20. This process stirs the wastewater stream 12 in the entry bay 20 and keeps the precipitate solids from accumulating on the floor 27 of the bay 20. Any solids or sludge that does collect will concentrate into and be pumped from the entry bay sump 22. Further the vertical curtain 28 disposed between the sump 22 and the entry bay inlet 24 further enhances the collection of the precipitate.

Another self-cleaning enhancement is the floor 44 of the settling bay 40 being a conical inverted cone shape, as shown in FIG. 3. Attached beneath the apex 45 is a solids collection sump 46. Gravity pulls the settling solids in the settling bay 40 to the apex 45, into the sump 46. Then, as needed any sludge may be pumped out of the sump 46 through an exit pipe 47 for discharge as described above.

The device 10 further includes several optional features that allow ease of maintenance. One such feature is a stairway 51 and catwalk 52, as shown in FIG. 1. The catwalk 52 extends over and above each of the bays 20, 40 and 60 and the stairway 51 leads from the catwalk to the ground. The stairway 51 and catwalk 52 allow an operator to view and inspect the chamber 20, 40 and 60 from the above. The stairway 51 and catwalk 52 further allow the operator to gain easy access to chambers 20, 40 and 60 for cleaning. The catwalk 52 includes a floor made of solid non-skid materials, having sides that wrap upward, acting as a tray to hold any possible sediment carried into the device 10 by operators, and sloped toward an entry door (not shown) so as to allow the operator to easily clean by spraying the catwalk 52 with water, thus preventing potential contamination of the processed water 14.

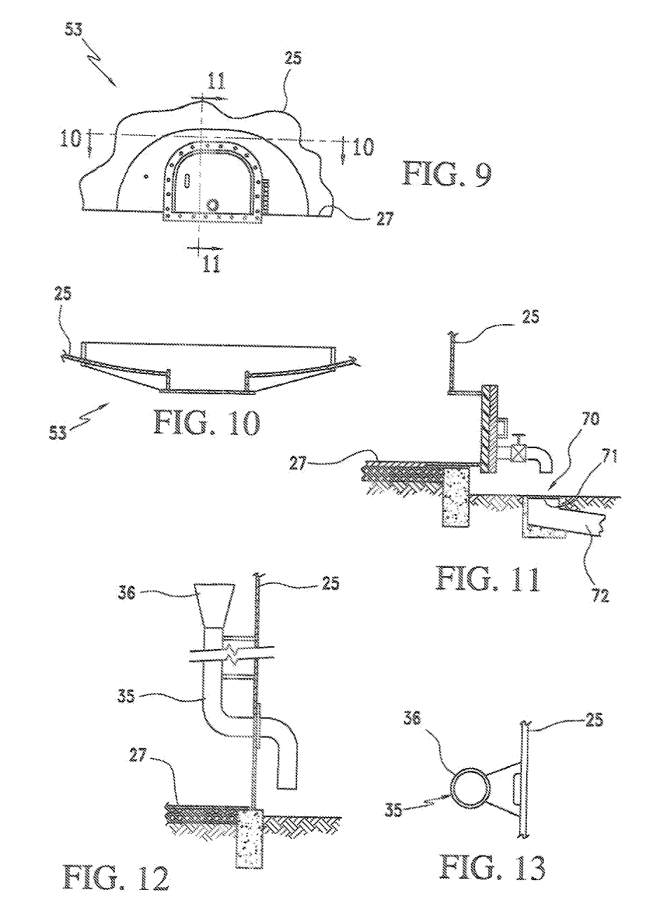

Another optional maintenance feature included in the device 10 is entryway 53, as shown in FIG. 1 and FIGS. 9 through 11. The entryway 53 is closed by a sealable door. It is further preferred that the entryway 53 be of a dog-house type or shaped entryway. The entryway 53 is installed in the entry bay 20 exterior wall 25 to allow the operator to access the entry bay 20. The entryway 53 is preferred to be disposed such that the door bottom is flush with the entry bay floor 27 to allow the entry bay 20 to be cleaned with a broom and push any waste material out the entryway 53 to the extent that is even necessary.

The entryway 53 also provides the additional safety purposes of providing access to the interior of the device 10 if the need to extract a person and/or equipment from the inside one of the chamber 20, 40 and 60 if required. Since the design of the entryway 53 is flush with the first chamber floor 27, it does not require the person being extracted to be lifted over the edge of the tank wall as required with typical or conventional devices which generally have man-way openings usually located above the tank bottom by 24 inches or more.

Still further the device 10 includes a catchment area 70 having a grate 71 and a drain 72, as shown in FIG. 11. The catchment area 70 is disposed exterior to the entryway 53. When entry bay 20 is being cleaned, an operator can open the door of the entryway 53 and push any sludge out the door and into the catchment area 70. The sludge can then be washed into a sewer via the drain 72.

Additionally, the device 10 includes a plurality of man-way access hatches 54 and 55 disposed within the wall 26 of the clearwell bay 60 and the wall 50 of the settling bay 40 respectively, as shown in FIG. 1. The man-way hatches 54 and 55 are similar to the entryway 53 and they also include sealable doors.

Still further, other optional maintenance features included in device 10 is a settling bay ladder (not shown), which allows access to the settling bay floor 44 if required. Additionally, each chamber 20, 40 and 60 include a plurality of bay drains (not shown), wherein each bay has a drain to allow complete draining of the tank for maintenance; and, external process and return pumps, wherein the process and return pumps are located on the outside of the tank for easy access and maintenance without having to drain the tank to repair or replace a pump.

The device 10 made in accordance with the present invention includes other advantageous features, such as for example, venting, pressure transducers and flow control valves (all not shown). It is further contemplated that the device 10 can be automated by the use of computers, sensors, automatic switches and pumps as is common in the art. The pressure transducers are solid state water level measuring devices to allow for the full automation of the device 10 and pumps 30 and 31. The pressure transducers further control the operation of process pumps 30 from the entry bay 20 into the settling bay 40 by indicating the volume of wastewater in the entry bay 20.

The device 10 also includes an optional rooftop 80, which includes a vent 81, as shown in FIG. 2. The roof vent 81 allows for fresh air to enter the chambers 20, 40 and 60.

Still another advantageous feature of the device 10 is the use of flexible piping, inlet pipe 21, outlet pipe 23, discharge line 47 and discharge line 64 between the bays 20, 40 and 60 to allow for normal movement, such as expansion and contraction of the chamber walls without causing undue stress or separating of the piping or walls. The flexible piping and seals will also compensate for misalignment during construction and aide in the prevention of leaks caused by shifting of the chambers in areas prone to earthquakes.

Further the device 10 incorporates the use of an overflow pipe 35, as shown in FIGS. 12 and 13. The overflow pipe 35 is disposed within the entry bay 20 and includes a flanged opening 36 operably configured to be disposed within the first chamber 20 above a maximum wastewater 12 level. The overflow pipe 35 protects the device 10 in the event of a mechanical or control failure. If the wastewater level in the entry bay 20 should rise above the overflow pipe 35, the wastewater will be dispensed outside the device 10.

In the device 10, made in accordance with the present invention, the preferred embodiment presents the order of the chambers has the entry bay 20 as the external outer most chamber, the settling bay 40 at the center and the clearwell bay 60 in between the entry bay 20 and settling bay 40. This order of the chambers 20, 40 and 60 has been found to be the most efficient. However, it should be that in other various exemplary embodiments, the order of the chambers may be varied.

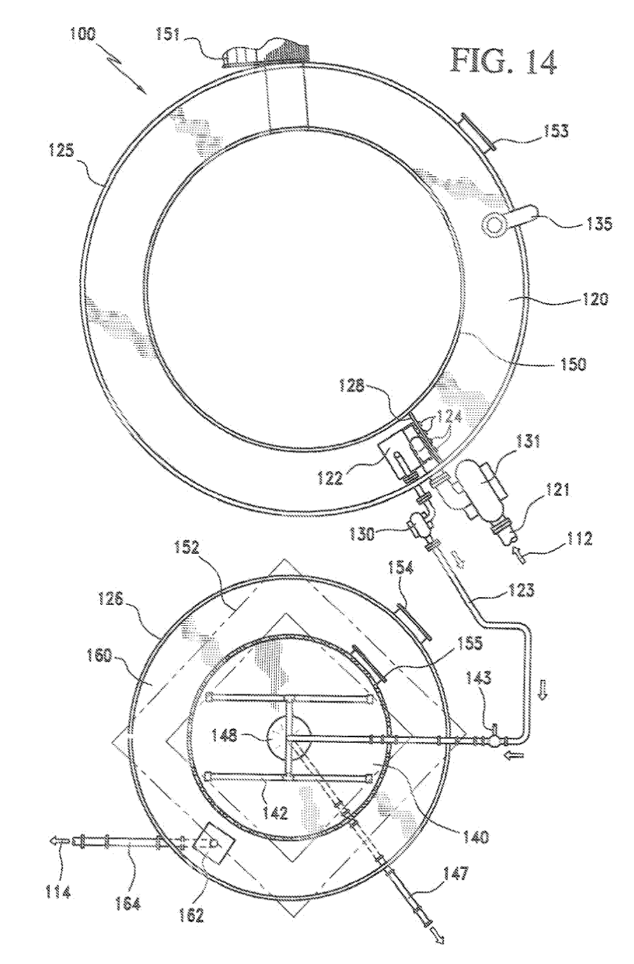

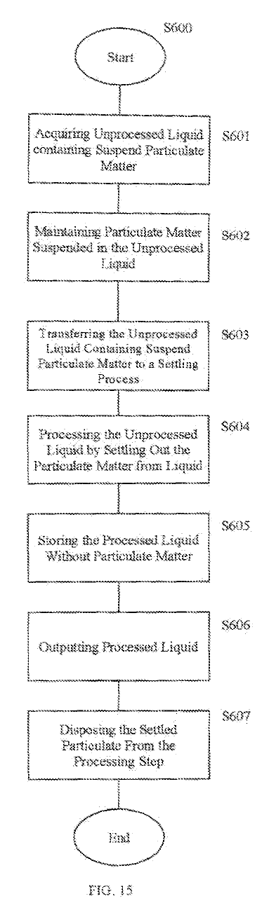

FIG. 14 is an alternative exemplary embodiment of device 100, made in accordance with the present invention. The device 100 is similar to the device 10 described above and includes similar features in that the device 100 has an entry bay 120, a settling bay 140 and a clearwell bay 160. The device 100 is further similar to the device 10 in that it also includes a directing device 124, an entry bay sump 122 and a settling bay distribution inlet 142.

Additional similarities between device 100 and 10 are that the device 100 includes a gated weir 141, a cone shaped floor 144 in the settling bay 140 and an inverted cone 148 over the settling bay floor 144. Still further, the device 100 includes the various pumps and plumbing as described in the device 10.

The device 100 is deferent from the device 10 in that the entry bay 120 is not integral with the clearwell bay 160 and settling bay 140, as shown in FIG. 14.

The device 100, as shown in FIG. 14, is used in an application where an existing a single conventional wastewater treatment filter backwash system has a tank located on the treatment site. This conventional treatment filter backwash system employs the batch type processing described above as being less efficient than the present invention. The existing tank is converted into the entry bay 120, in accordance with this invention. The clearwell bay 160 and settling bay 140 are constructed as an integral tank separate from the entry bay 120. The settling bay 140 is in fluid communication with the entry bay 120. Further, it is preferred that the clearwell bay 160 and settling bay 140 construction be disposed in close proximity to the preexisting tank.

The entry bay 120 is created by converting the pre-existing tank. Particularly, it is preferred that the pre-existing device be outfitted or modified to include all the features of the entry bay 20 as described above for the device 10. Some examples of these added features would be the directing device 124 and an interior circular wall 150 of the entry bay 120. The circular wall 150 and the directing device 124 will allow the converted existing tank to suspend precipitates in the liquid that entered the tank through the directing device 124. It should be appreciated that in other various exemplary embodiments the interior circular wall need not be added to the existing tank.

Other features are also preferred to be added to the existing tank, such as adding an entry bay sump 122 with an entry bay outlet pipe 123 providing fluid communication between the entry bay 120 and the settling bay 140. The water with the suspended solids is pumped from the sump 122 of the entry bay 120 through the outlet pipe 123 by a process pump 130. It is further preferred that the existing tank be further modified to include a curtain wall 128 separating the directing device 124 from the entry bay sump 122 similar to the curtain wall 28 for the device 10.

By adapting the existing tank to act as the entry bay 120, the features and benefits of the present invention, especially the continuous flow type process, can be provided to the existing system, which previously employed a batch type process. The backwash device 100, made in accordance with the present invention, has the clearwell bay 160 with the settling bay 140 internal as in device 10 described above. The two chambers 140 and 160 utilize with the existing entry bay 120 to minimize construction costs and use the least amount of land space.

The present invention further includes a method of separating suspended particulate matter from liquids. An exemplary embodiment of a method in accordance with this invention is method S600, shown in FIG. 15. The method S600 includes the steps of acquiring unprocessed liquid containing suspended particulate matter S601; maintaining the particulate matter suspended within the unprocessed liquid S602; transferring the unprocessed liquid containing suspended particulate matter to a settling process S603; processing the unprocessed liquid by settling out the particulate from the liquid S604; storing the processed liquid without particulate matter S605; outputting the processed liquid step S606; and disposing the settled particulate matter from the processing step S607.

The method S600 can be used in a variety of applications of treating liquids. An exemplary use for this method is in wastewater treatment applications and particularly to the treatment of wastewater backwash. The following description of the steps of method S600 is for the exemplary embodiment wherein the method is used in connection with the treatment of wastewater backwash liquid stream that requires the removal of solids/particulates. Further, the devices 10 and 100 are exemplary embodiments of devices/systems that are operably configured to carry out the methods of this invention, including method S600. The steps of method S600 will be discussed with reference to the components of the device 10 described above. However, it will be appreciated that the methods of this invention can be carried out by other devices and systems.

The method S600 is configured to enable the continuous processing of liquids rather than the inefficient batch type processing that convention methods provide. In a conventional wastewater treatment facility, the wastewater treatment must be stopped for wastewater filters to be backwashed. The process of the present invention allows for the wastewater treatment facility to continue operating while the wastewater filters are being backwashed.

Step S601 of acquiring the unprocessed liquid containing suspended particulate matter includes obtaining a feed or stream of liquid containing suspended particulate matter. In this exemplary embodiment, this step includes pumping wastewater backwash stream 12 from a water treatment facility into the first chamber 20.

Step S602 of maintaining the particulate matter suspended within the unprocessed liquid, includes agitating the unprocessed liquid within a container. In this exemplary embodiment, Step 602 includes directing the backwash stream 12, from step S601, in a direction parallel to the floor 27 by the use of the nozzles 24. It is preferred that the entire stream be directed in a similar orientation or direction. However, it should be appreciated that non-uniform directing could be utilized in other exemplary embodiments. Step S602 includes circulating the liquid within the first circular chamber 20, which has a concentric inner and outer wall.

Step 603 of transferring the unprocessed liquid containing suspended particulate matter to a settling process, includes continuously transferring the liquid from step S602 to a second or settling chamber. The transferring is accomplished using any fluid communication methods. In this exemplary embodiment, the process pump 30 is utilized to send a continuous flow of the liquid containing suspended particulate from step S602 into the second chamber 40 at a controlled rate of flow. The transferring rate is dependent upon the settling velocity of the precipitates in the wastewater 12. Since suspended particulates within a liquid settle at differing rates, depending on the type of particulate and the type of liquid, the transferring rate is controlled by an operator, either manually or automatically so as not to exceed the settling velocity through varied operation of the process pump 30. Another factor in determining the settling velocity is the clarity desired by the operator for the processed liquid. The settling velocity can be determined on an as needed basis by the operator for the type of particulate and the desired clarity.

Additionally, the second chamber includes an inlet, a top, a bottom, a processed liquid outlet and a sealable settlement outlet, the inlet being in fluid communication with the first chamber and being disposed within the second chamber closer to the bottom of the second chamber than the top, such that during the transferring the unprocessed liquid containing suspended particulate matter to a settling process, step S603, the unprocessed liquid is transferred to the second chamber in a generally horizontal direction within the second chamber.

Step S604 of processing the unprocessed liquid by settling out the particulate from the liquid includes providing a settling chamber wherein the liquid transferred from step S603 is contained. The force of gravity pulls the particulates, which are heavier than the liquid that particulates are suspended within, toward the bottom of the chamber. Step S604 further includes providing a substantially calm liquid environment within the settling chamber. Substantially calm liquid environment includes a non-agitation state wherein the force of gravity is allowed to overcome any agitation forces present in the chamber so as to pull down the targeted particulate determined to be settled by the operator. The settling chamber in this exemplary embodiment is the second chamber 40 of the device 10.

Step S604 preferably includes directing the transferring the liquid from step S603 in a horizontal direction at the controlled rate of flow dependent upon the settling velocity of the precipitates in the wastewater 12. In this exemplary embodiment this horizontal disbursement of the liquid from step S603 is carried out by the inlet or manifold 42 of the device 10. Further, it is preferred that the distribution be spread out across the area of the chamber and horizontally within the chamber. These features will assist in minimizing the agitation within the settling chamber, so that the force gravity my pull more of the precipitates down to the bottom of the chamber as discussed above.

Step S604 further includes transferring the processed liquid into a third chamber. The transferring of the processed liquid from step S604 is carried out by allowing the settling chamber in step S604 to fill up and lip over the top of the settling chamber and into the third chamber. In this exemplary embodiment, as the setting bay 40 fills up with the processed water 14, the processed water 14 flows through the V-notch weir 41 and into the clearwell bay 60.

Step S604 further includes collecting the settled particulate at a collection point. It is preferred that the collecting of settled particulate include funneling to an apex. An exemplary embodiment of these features can be found in the cone-shape floor 44 with an apex 45 of the settling bay 40 as described above, which also includes a smaller inverted cone 48 with an apex 49 pointed upwards disposed over the apex 45 of the cone floor 44. Gravity pulls the settled particulate into the apex 45 of the cone floor 44. The inverted cone 48 helps to reduce agitation within the settling bay 40 as the particulate settles. Also, as the particulate settles, the particulate is pulled down the inverted cone 48. As the particulate leaves the inverted cone 48, the particulate comes in contact with the cone floor 44 providing a shearing effect to aide the settled particulate towards the floor apex 45.

The method S600 continues with the S605 step, storing the processed liquid without particulate matter S605. In step S605, the processed liquid is stored for future use in the third chamber. An exemplary embodiment of these features can be found in the clearwell bay 60 described above. The processed liquid, without particulate is contained within the clearwell bay 60 until transferred to the treatment facility.

The method S600 includes the step S606, outputting the processed liquid step S606. The sump 62 and discharge pipe 64 of the clearwell bay 60 are exemplary embodiments of how the processed liquid is transferred back to the treatment facility. In this embodiment no mechanical pumps are required since the sump 62 and the discharge pipe 64 are disposed on the bottom of the clearwell bay. However, it should be appreciated that in other various exemplary embodiments, other methods of transferring the processed liquid, such as pumps may be used to output the processed water back to the treatment facility at a transfer rate required by the treatment facility.

The method according to this invention also includes the disposing the settled particulate matter from the processing step S607. In step S607, settled particulate from the collecting the settled particulate at a collection point in step S604 is removed from the second or settling chamber. As described above, the sump 46 and the conveyance piping 47 is an exemplary embodiment of how the settled particulate are removed from the settling bay 40. The step S607 may be conducted concurrently or separately from steps S605 and S606. Once settled particulate collects into the sump 46, an operator may remove the settled particulate at any time with disrupting the settling process in the processing the unprocessed liquid by settling out the particulate matter from liquid, S604.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A device for removing particulates from a liquid comprising:
a first chamber having an outlet and an inlet, operably configured to receive into the first chamber a liquid stream having particulates suspended therein;
a second chamber having an inlet, a top, a bottom, a processed liquid outlet and a sealable settlement outlet, the inlet being in fluid communication with the outlet of the first chamber and being disposed within the second chamber closer to the bottom of the second chamber than the top; and,
a third chamber being in fluid communication with the processed water of the second chamber and having an exit line operably configured to deliver processed water.

2. The device, as recited in claim 1, wherein the first chamber further includes a floor and the inlet of the first chamber is operably configured to direct the liquid stream is a direction substantially parallel to the floor.

3. The device, as recited in claim 1, wherein the first chamber includes an outer and inner wall being substantial concentric circles and wherein the inlet of the first chamber is operably configured to direct the liquid stream in a circular motion about the inner wall.

4. The device, as recited in claim 1, wherein the first chamber further includes a floor, a separator wall and a sump, the sump is disposed adjacent the inlet of the first chamber and recessed in the floor, and the separator wall is disposed between the inlet and the sump.

5. The device as recited in claim 1, wherein the inlet includes at least one nozzle operably configured to, when in use, agitate the liquid within the first chamber to maintain suspension of the particles within the liquid.

6. The device as recited in claim 1, wherein the inlet of the second chamber includes a plurality of orifices, wherein when in use the inlet is operably configured to dispense the liquid from the first chamber in generally a horizontal direction within the second chamber.

7. The device as recited in claim 1, wherein the inlet of the second chamber is a manifold having a plurality of orifices and being generally oriented in a horizontal direction.

8. The device as recited in claim 1, wherein the second chamber further comprising a chemical injection line operably configured to inject a chemical into the liquid to be disbursed by the inlet of the second chamber.

9. The device, as recited in claim 1, wherein the processed liquid outlet of the second chamber includes a weir.

10. The device, as recited in claim 1, wherein the second chamber includes an outer wall having a top rim, wherein the processed liquid outlet of the second chamber is the top rim, and wherein the top rim includes at least one v-shaped notch.

11. The device, as recited in claim 1, wherein the second chamber is disposed within the third chamber.

12. The device, as recited in claim 1, wherein the bottom of the second chamber has an inverted conical shape and the settlement outlet is disposed at an apex of the conical shaped bottom, and wherein the settlement outlet is a sump.

13. The device, as recited in claim 12, wherein the second chamber further includes a second conical cone shaped member disposed above the apex conical shaped bottom.

14. The device, as recited in claim 1, wherein the third chamber is disposed within the first chamber.

15. The device, as recited in claim 1, wherein the third chamber is disposed within the first chamber and the second chamber is disposed within the third chamber.

16. The device, as recited in claim 1, where the first, second and third chambers each include an access door.

17. A wastewater backwash multi-chambered cleaning device comprising:
an entry bay having a floor, a sump, and at least one inlet operably configured to connect with a backwash source and when in use to direct the backwash from the backwash source in a substantially horizontal direction along the floor, the sump being recessed into the floor adjacent to the at least one inlet;
a clearwell bay having a discharge line, and being disposed in the entry bay; and,
a settling bay being disposed in the clearwell bay and having a weir, a conical shaped floor with a settlement sump at the apex, and an inlet manifold being disposed within the settling bay, operably configured to receive backwash from the sump of the entry bay and discharge the backwash in a horizontal direction, wherein the settlement sump has a closeable opening and the weir is in fluid communication with the clearwell bay.

18. The device as recited in claim 17, further comprising first and second pumps, and wherein when the device is in use, the backwash enters the entry bay via the at least one inlet, the first pump is operably configured to force the backwash to the manifold of the second chamber, the settling bay is operably configured to permit solids within the backwash to settle to the floor of the settling bay, as settling occurs the wastewater level rises in the settling bay to a level where wastewater without particulate drains over the weir to the clearwell bay and, the second pump is operably configured to force the wastewater without particulate out through the discharge line.

19. The device, as recited in claim 17, wherein the entry bay, settling bay and clearwell bay are circular.

20. The device, as recited in claim 17, further comprising a roof over the entry bay, the settling bay and the clearwell bay.

21. The device, as recited in claim 17, as recited in claim wherein the manifold is disposed within the settlement bay closer to the floor than to the weir.

22. A method of treating wastewater backwash, comprising the steps of:
acquiring unprocessed liquid containing suspended particulate matter;
maintaining the particulate matter suspended within the unprocessed liquid;
transferring the unprocessed liquid containing suspended particulate matter to a settling process;
processing the unprocessed liquid by settling out the particulate matter from the liquid;
storing the processed liquid without particulate matter; and,
outputting the processed liquid.

23. The method, as recited in claim 22, further including an injecting step, wherein injection of chemical coagulants may be added to the processing step.

24. The method, as recited in claim 22, further including a disposing of the settled particulate matter from the processing step.

25. The method, as recited in claim 22, wherein during the transferring the liquid containing suspended particulate matter step, the liquid is transferred at a rate less than the particulate settling velocity in the processing step.

26. The method, as recited in claim 22, wherein the second chamber is disposed within the third chamber and the third chamber is disposed within the first chamber.

27. The method, as recited in claim 22, wherein during the transferring step, the unprocessed liquid is transferred to a second chamber, which includes an inlet, a top and a bottom, the inlet being disposed within the second chamber closer to the bottom of the second chamber than the top, such that during the transferring the unprocessed liquid containing suspended particulate matter to a settling process step, the unprocessed liquid is transferred to the second chamber in a generally horizontal direction within the second chamber.
